(19) United States
(12) Patent Application Publication
(10) Pub. No.: US 2006/0130683 A1
(43) Pub. Date: Jun. 22, 2006

(54) Turner bar unit for a web-fed rotary press

(75) Inventors: Johannes Behmel, Plauen (DE); Ulrich Seyffert, Syrau (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/304,155

(22) Filed: Dec. 15, 2005

(30) Foreign Application Priority Data
Dec. 17, 2004 (DE) 10 2004 060 725.7

(51) Int. Cl. B41F 13/54

(52) U.S. Cl. 101/228

(57) ABSTRACT

In a turner bar unit having turner bars arranged one above another in a plurality of planes, unscrewed webs of a web printing material can be inserted into the turner bar unit from the sides, in a plurality of planes arranged one above another on each side. The webs of the web printing material can be divided into part webs at cutting devices arranged upstream of the turner bars in the insertion direction of the printing material on each side, and the part webs can be deflected or turned at the turner bars in such a way that the part webs can exit the turner bar unit at right angles to the insertion direction of the printing material.

### BACKGROUND OF THE INVENTION

1. Field of the Invention

The invention relates to a turner bar unit for a web-fed rotary press wherein a web received in an insertion direction is severed into part webs which leave the unit in an exit direction at right angles to the insertion direction.

2. Description of the Related Art

At a turner bar unit of a web-fed rotary press, webs of a web printing material, which can be fed to the turner bar unit in a plurality of planes arranged one above another, are divided into part webs, the part webs being turned through approximately 90° on turner bars of the turner bar unit, such that the part webs leave the turner bar unit in an exit direction which runs approximately at right angles to an insertion direction of the uncut webs of the web printing material into the turner bar unit. Here, the webs of the unsevered printing material are fed to the turner bar unit from one side, the severed part webs of the printing material leave the turner bar unit on a side of the same offset through 90°.

U.S. Pat. No. 6,082,259 discloses turner bar units for a web-fed rotary press in which the web printing material can be inserted into the turner bar unit from one side, and in which the turned part webs of the printing material can be guided out of the turner bar units on two mutually opposite sides. According to this patent, two such turner bar units can be arranged in mirror image fashion in relation to each other such that, into each of the two turner bar units positioned in mirror image fashion in relation to each other, the unsevered web printing material can be inserted from one side, the insertion directions into the different turner bar units being offset by about 180° in relation to each other. Accordingly, each of the turner bar units can be fed with the unsevered web printing material only from one side.

### SUMMARY OF THE INVENTION

On this basis, the present invention is based on the problem of providing a novel turner bar unit for a web-fed rotary press.

According to the invention, the webs of the web printing material can be inserted into the turner bar unit from two sides.

In the spirit of the present invention, a turner bar unit for a web-fed rotary press is proposed, it being possible for the webs of the web printing material to be inserted simultaneously into the turner bar unit from two mutually opposite sides. By using the turner bar unit according to the invention, as compared with the prior art, considerable advantages in terms of space and in terms of costs can be realized during the integration of the same into a web-fed rotary press.

The webs of the web printing material can be fed simultaneously from two mutually opposite sides to the turner bars of the turner bar unit, arranged one above another in a plurality of planes, in such a way that the two feed directions are offset by about 180° in relation to each other.

According to an advantageous development of the present invention, the part webs of the web printing material can be led out of the turner bar unit on two mutually opposite sides, in such a way that the two exit directions are offset by about 180° in relation to each other and in each case by about 90° in relation to the two insertion directions of the webs of the web printing material into the turner bar unit.

Preferred developments of the invention emerge from the following description. Exemplary embodiments of the invention, without being restricted thereto, will be explained in more detail by using the drawing.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a plan view of a turner bar unit according to the invention for a web-fed rotary press according to a first exemplary embodiment of the invention;

FIG. 2 shows a cross section of the turner bar unit of FIG. 1 along the section line II-II;

FIG. 3 shows a cross section of the turner bar unit of FIG. 1 along the section line III-III;

FIG. 4 shows a plan view of a turner bar unit according to the invention for a web-fed rotary press according to a second exemplary embodiment of the invention;

FIG. 5 shows a plan view of a turner bar unit according to the invention for a web-fed rotary press according to a third exemplary embodiment of the invention;

FIG. 6 shows a plan view of a turner bar unit according to the invention for a web-fed rotary press according to a fourth exemplary embodiment of the invention;

FIG. 7 shows a plan view of a turner bar unit according to the invention for a web-fed rotary press according to a fifth exemplary embodiment of the invention;

FIG. 8 shows a plan view of a turner bar unit according to the invention for a web-fed rotary press according to a sixth exemplary embodiment of the invention;

FIG. 9 shows a plan view of a turner bar unit according to the invention for a web-fed rotary press according to a seventh exemplary embodiment of the invention;

FIG. 10 shows a plan view of a turner bar unit according to the invention for a web-fed rotary press according to an eighth exemplary embodiment of the invention;

FIG. 11 shows a detail from the web-fed rotary press according to the invention; and

FIG. 12 shows a further detail from the web-fed rotary press according to the invention.

### DETAILED DESCRIPTION OF THE PRESENTLY PREFERRED EMBODIMENTS

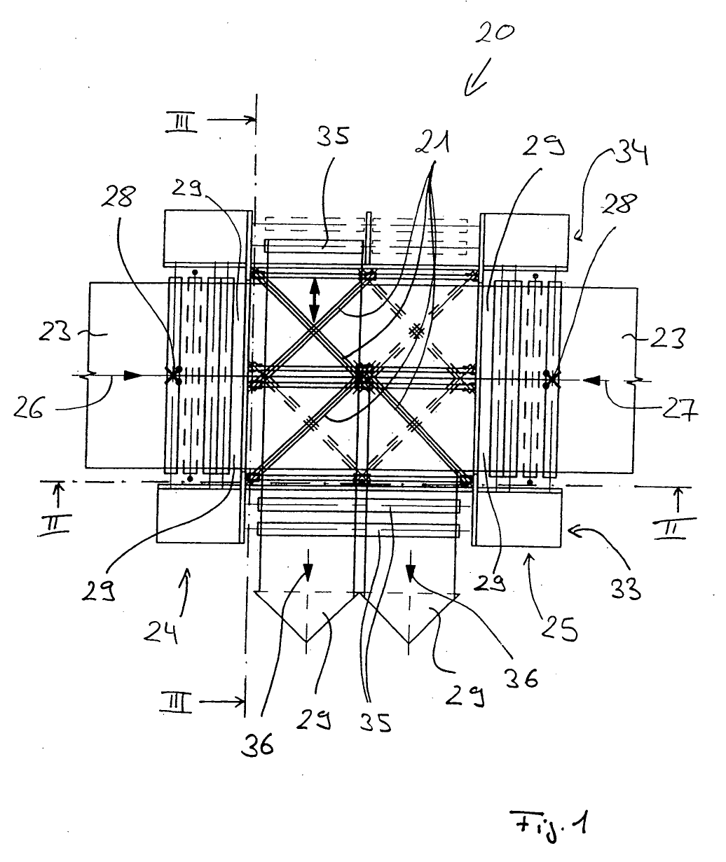

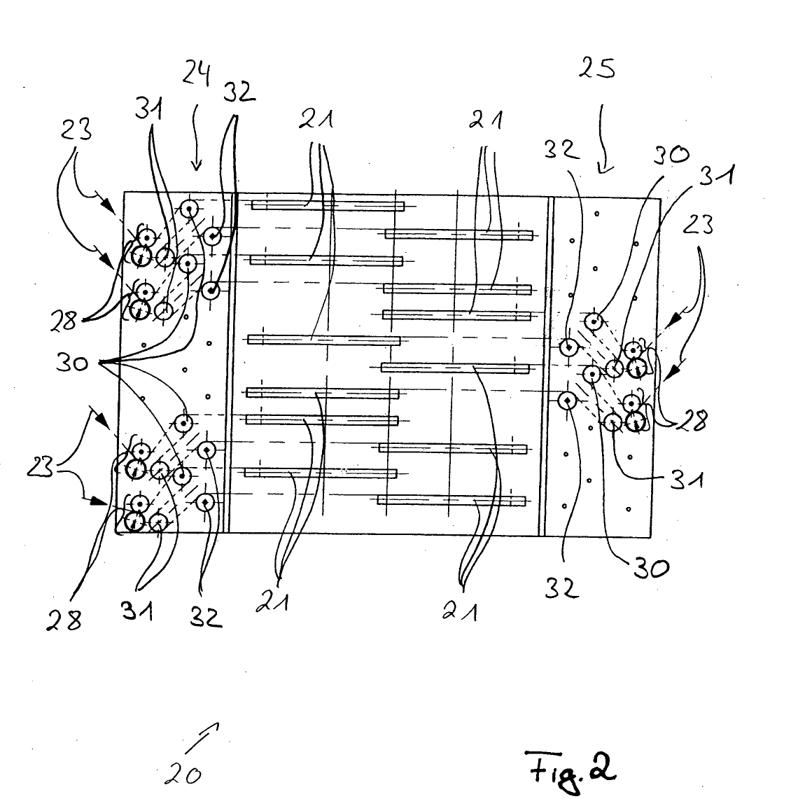

In the following text, the present invention will be described in greater detail with reference to FIGS. 1 to 12.

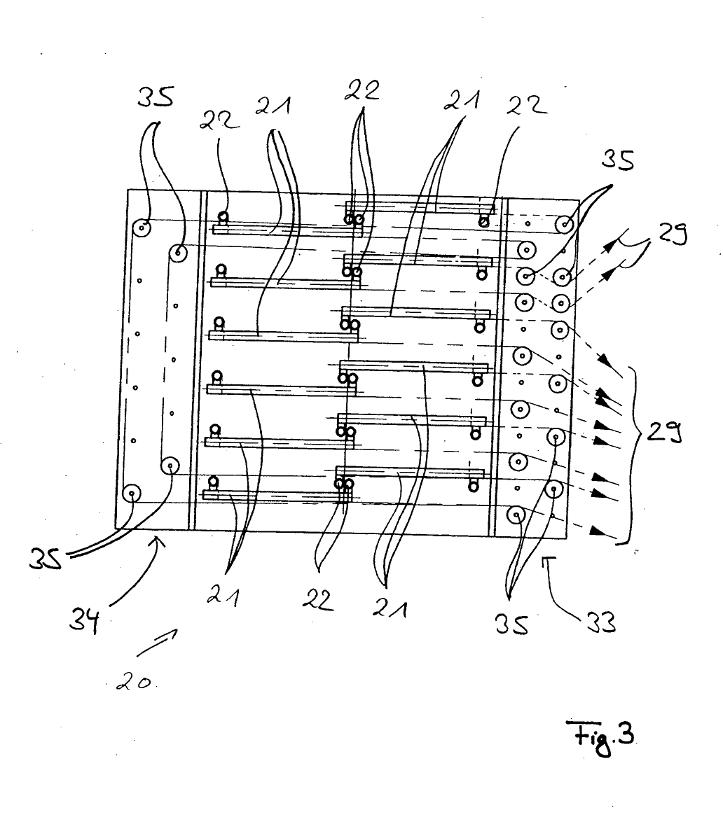

FIGS. 1 to 3 show a first exemplary embodiment of a turner bar unit 20 according to the invention, the turner bar unit 20 having a large number of turner bars 21 which are arranged one above another in a plurality of planes. The turner bars 21 are guided in guides 22 (see FIG. 3) and are designed to be adjustable along these guides 22.

Webs 23 of a web printing material can be inserted simultaneously from two mutually opposite sides 24 and 25 into the turner bar unit 20 according to the invention of FIGS. 1 to 3. Insertion directions 26 and 27 of the webs 23 of the web printing material into the turner bar unit 20 are offset by 180° in relation to each other, according to FIG. 1. This means that, in the region of the side 24, webs 23 can be inserted from the left and, in the region of the side 25, webs 23 can be inserted from the right into the turner bar unit 20.

Positioned on both mutually opposite sides 24 and 25 of the turner bar unit 20 on which the webs 23 can be inserted into the turner bar unit 20 are cutting devices 28, on which the webs 23 of the printing material supplied in a plurality of planes arranged one above another are divided into part webs 29. The part webs 29 can be fed over rolls 30, 31 and 32 arranged after the cutting devices 28 to the turner bars 21, the rolls 30 being designated pull rolls, the rolls 31 being designated register rolls and the rolls 32 being designated web-guiding rolls.

The part webs 29 are deflected or turned on the turner bars 21 of the turner bar unit 20 and, in the exemplary embodiment of FIG. 1, are led out of the turner bar unit 20 on a side 33 of the same. On a side 34 of the turner bar unit 20 opposite to the exit side 33, what is known as bay-window turning of the left-hand part web 29 shown in FIG. 1 is carried out. Rolls 35 for the guidance of the part webs 29 are positioned in the region of the two sides 33 and 34 of the turner bar unit 20 which are arranged at right angles to the two insertion sides 24 and 25 of the same.

Accordingly, in the exemplary embodiment of FIGS. 1 to 3, it is possible for webs 23 of a printing material to be inserted simultaneously into the turner bar unit 20 from two mutually opposite sides 24 and 25 in the turner bar unit 20 according to the invention. The insertion directions 26 and 27 into the two sides 24 and 25 are offset by about 180° in relation to each other. In the region of the two insertion sides 24 and 25, the webs 23 of the printing material are divided into part webs 29 and turned through 90° in the region of the turner bars 21. In the exemplary embodiment of FIGS. 1 to 3, the turned part webs 29 leave the turner bar unit 20 according to the invention on a side 33 which is arranged at right angles to the two insertion sides 24 and 25. In the exemplary embodiment of FIGS. 1 to 3, the side 34 of the turner bar unit 20 which is opposite the exit side 33 is used to provide what is known as bay-window turning in the region of a part web 29.

In the exemplary embodiment of FIGS. 1 to 3, in the region of the two insertion sides 24 and 25, the turner bar unit 20 is supplied with double-width webs 23 of the printing material, which are divided centrally in the region of the cutting devices 28 and leave the turner bar unit 20 in the region of the exit side 33 as single-width part webs 29. As already mentioned many times, the part webs 29 produced in the region of the cutting devices 28 are turned or deflected on the turner bars 21, specifically in such a way that the exit direction 36 of the part webs 29 in each case runs at right angles to the insertion directions 26 and 27 of the webs 23.

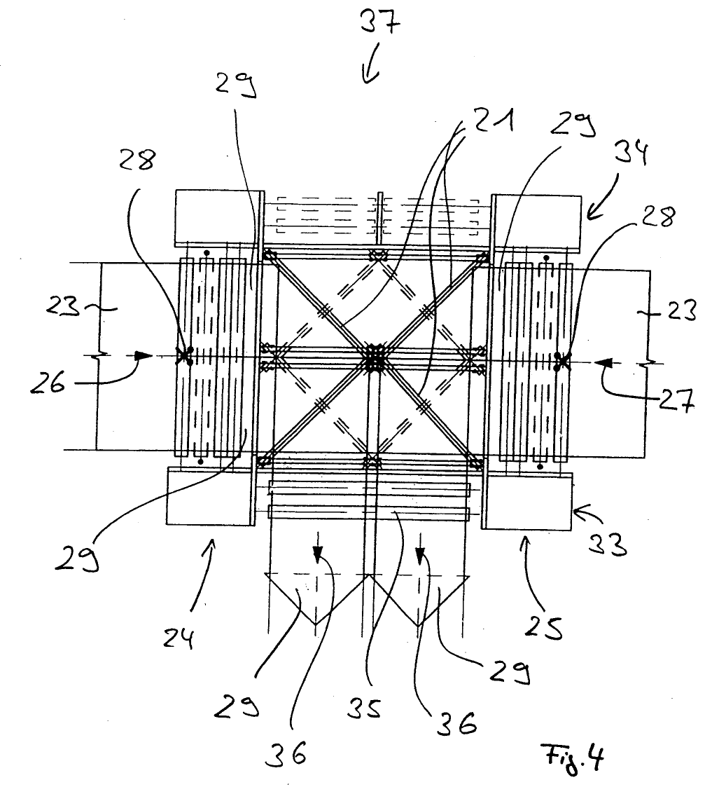

FIG. 4 shows a second exemplary embodiment of a turner bar unit 37. The turner bar unit 37 of FIG. 4 corresponds substantially to the turner bar unit 20 of FIG. 1, so that, in order to avoid unnecessary repetitions, the same reference numbers are used for the same subassemblies. The turner bar unit 37 of FIG. 4 differs from the turner bar unit 20 of FIG. 1 only in that, in the region of the side 34 which is opposite the exit side 33, no bay-window turning, as it is known, of the part webs 29 is carried out. With regard to the remaining details, the turner bar unit 37 of FIG. 4 corresponds to the turner bar unit 20 of FIG. 1, so that reference can be made to the above explanations.

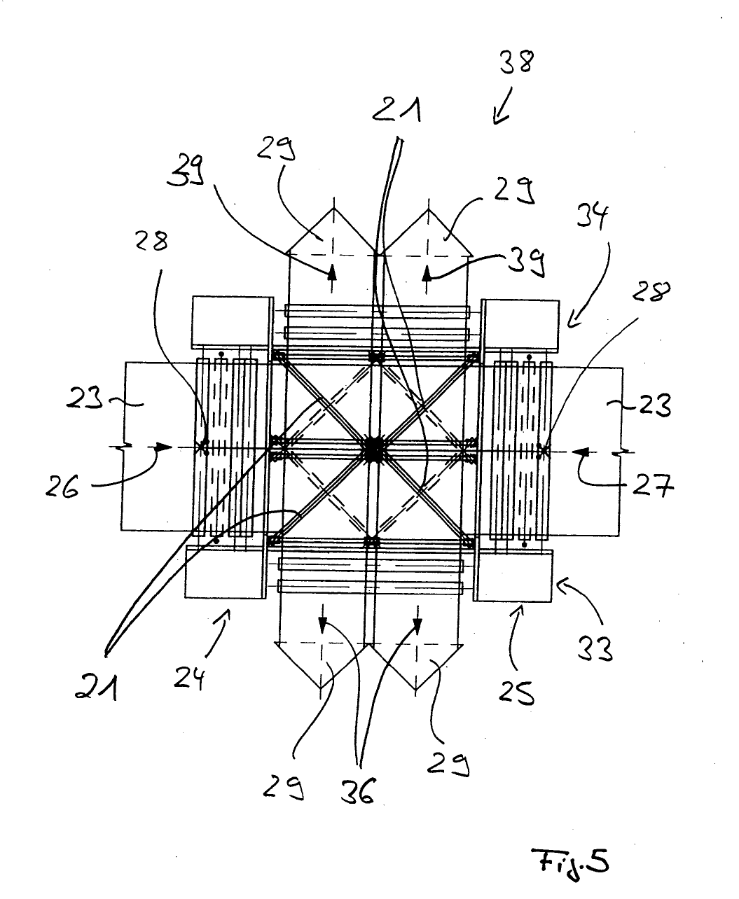

FIG. 5 shows a further embodiment of a turner bar unit 38 according to the invention, the turner bar unit 38 of FIG. 5 differing from the turner bar unit 37 of FIG. 4 only in that, in the turner bar unit 38 of FIG. 5, the part webs 29 can be led out of the turner bar unit 38 on two mutually opposite sides 33 and 34. The exit directions 36 and 39 in the region of the mutually opposite exit sides 33 and 34 are offset by about 180° in relation to one another and, furthermore, are in each case offset by about 90° in relation to the insertion directions 26 and 27 of the webs 23.

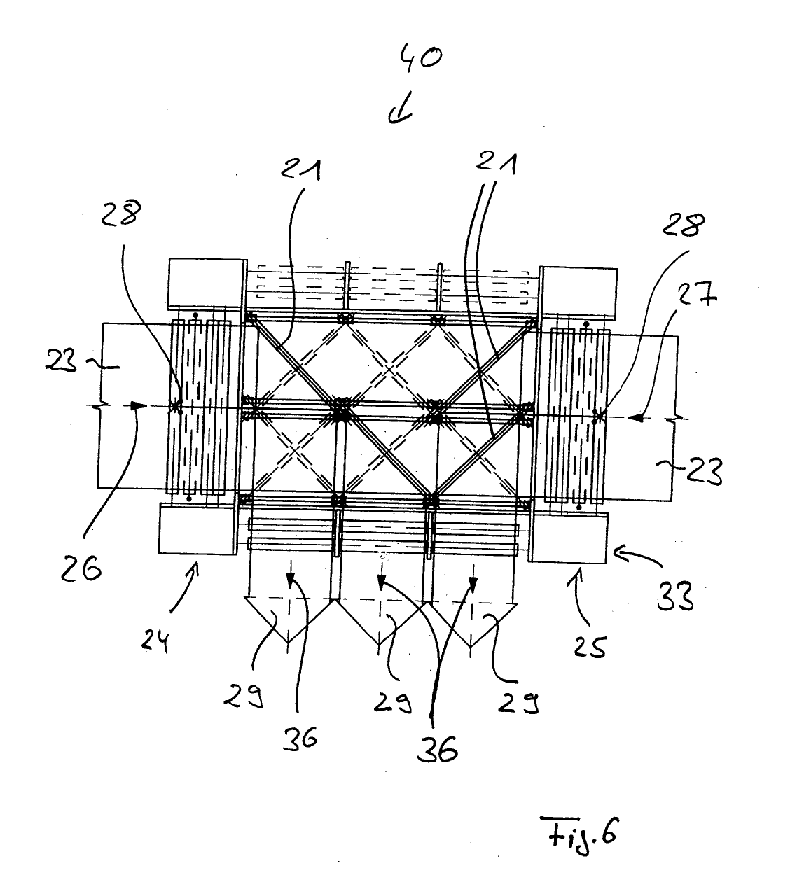

FIGS. 6 to 10 show further embodiments of turner bar units 40, 41, 42, 43 and 44 according to the invention, the turner bar units 40 to 44 differing from the turner bar units 20, 37 and 38 substantially only in the width of the webs 23 inserted into the turner bar units or in the number of streams lying beside one another of part webs 29 led out of the same.

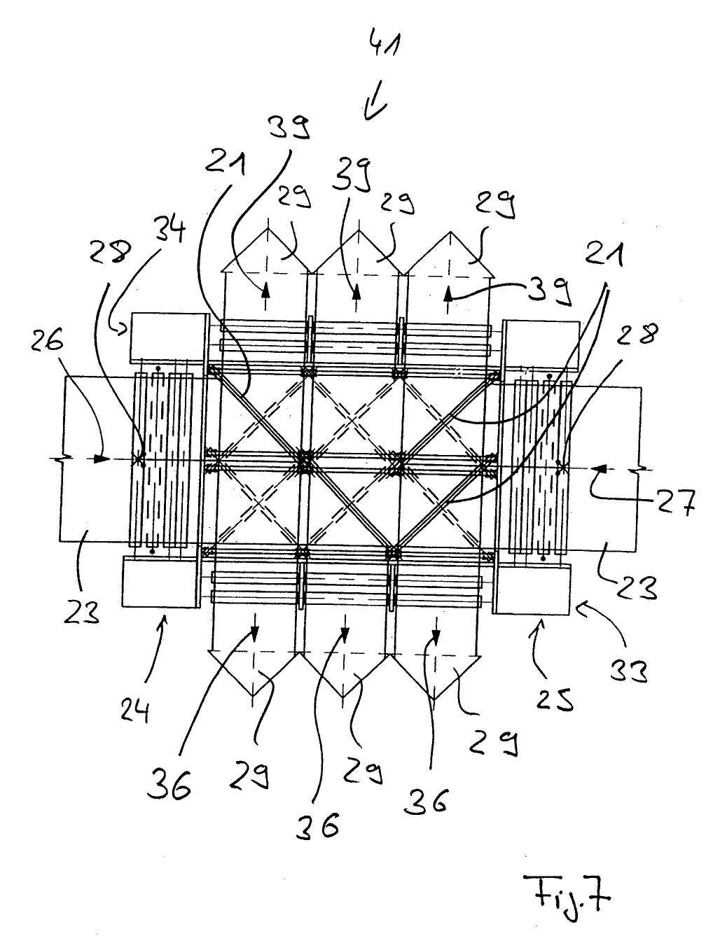

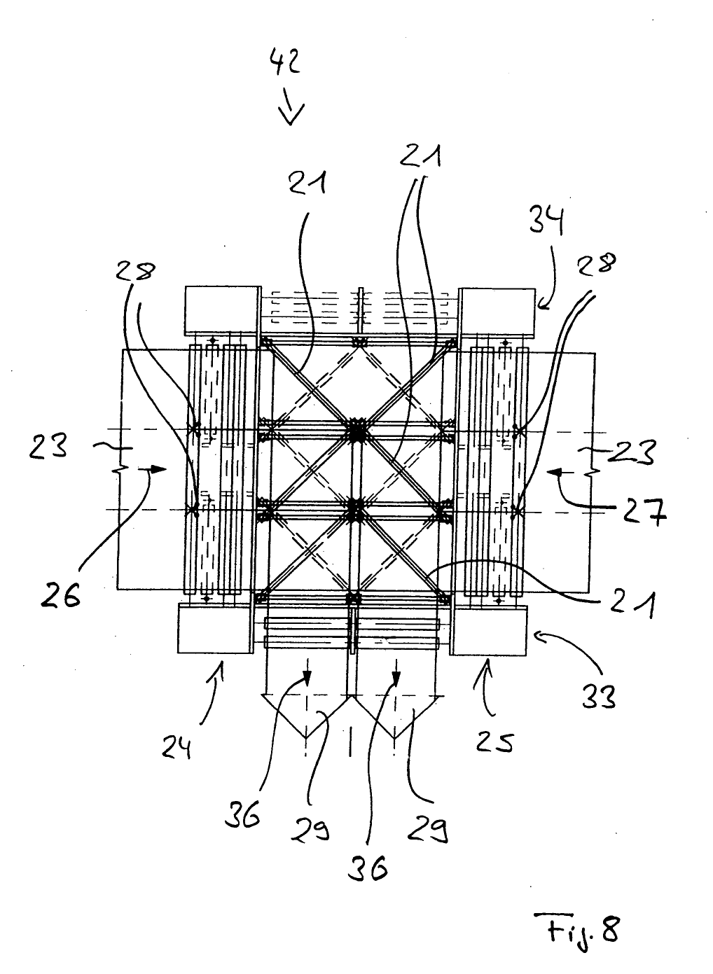

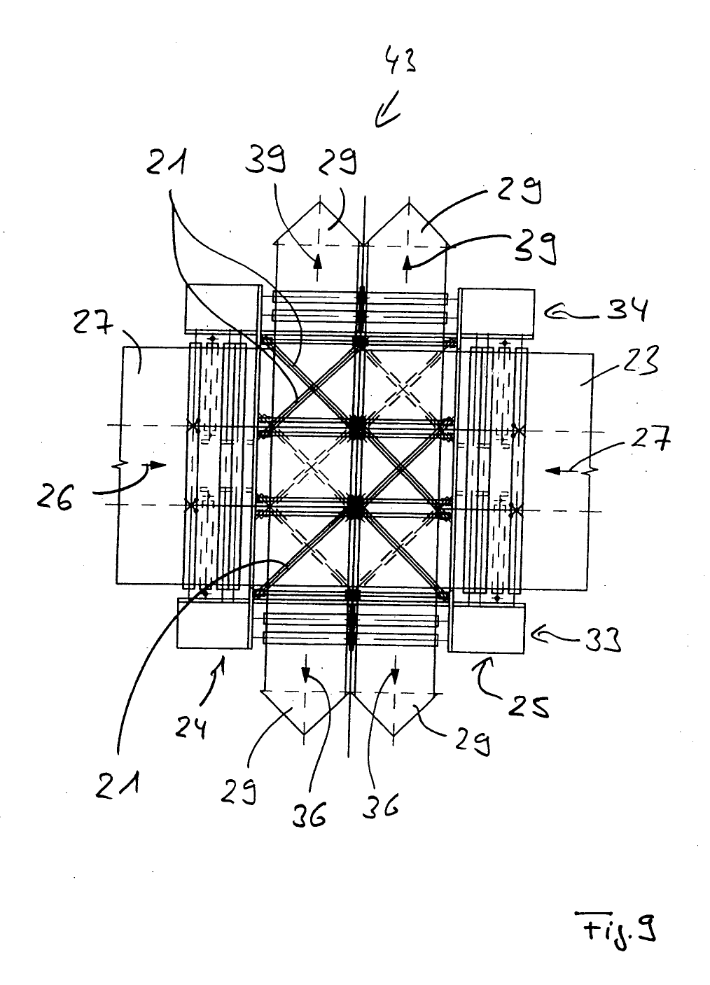

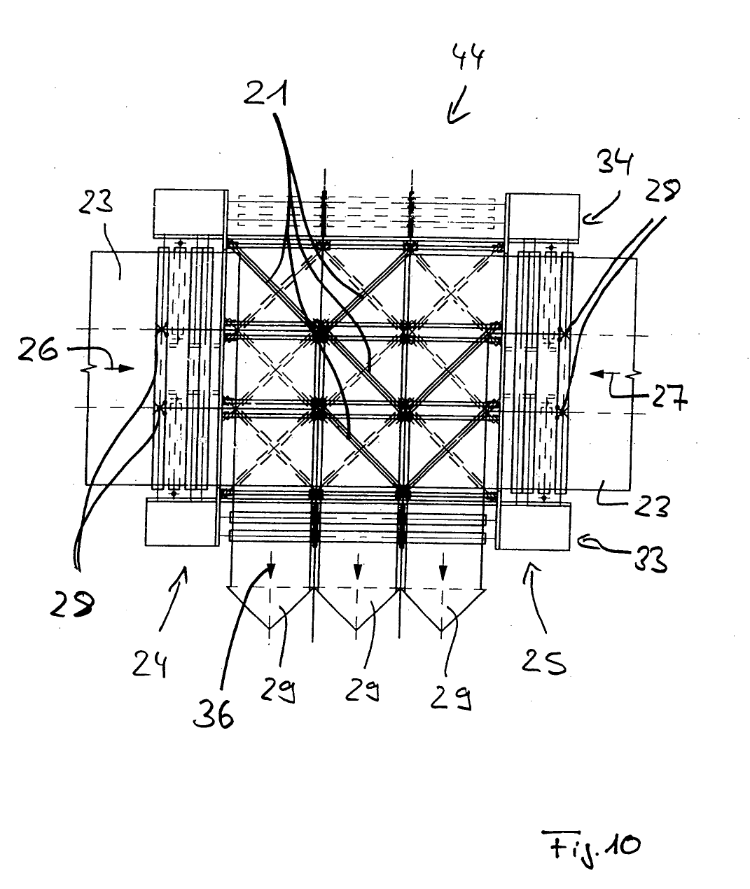

Thus, in each case double-width webs 23 of the printing material are fed to the turner bar unit 40 according to the invention of FIG. 6 in the region of the two sides 24 and 25; in the region of an exit side 33, part webs 29 can be led out of the turner bar unit 40 in three streams lying beside one another. In the exemplary embodiment of FIG. 7, the part webs 29 are led out of the turner bar unit 41 on both sides 33 and 34, specifically again in the form of three streams lying beside one another in each case. In the exemplary embodiment of FIG. 8, triple-width webs 23 are inserted into the turner bar unit 42 in the region of the two insertion sides 24 and 25, each triple-width web 23 being divided into single-width part webs 29 by two cutting devices 28, the part webs 29 being turned on the turner bars 21 and, moreover, it being possible for the single-width part webs 29 in each plane of the turner bar unit 42 to be led out from the same in the form of two streams lying beside each other. In the exemplary embodiment of FIG. 8, the part webs 29 are led out only on an exit side 33; in the turner bar unit 43 of FIG. 9, on the other hand, they are led out on two mutually opposite sides 33 and 34. FIG. 10 shows a turner bar unit 44 in the spirit of the present invention to which a plurality of triple-width webs 23 can be fed simultaneously in a plurality of planes arranged one above another in the region of both insertion sides 24 and 25, the said triple-width webs 23 in turn being divided into single-width part webs 29 and, following the deflection of the same in the region of the turner bars 21, leaving the turner bar unit 44 in the region of one side 33, specifically in the region of three streams lying beside one other. It is obvious that further variations with regard to the width of the webs 23 inserted into the turner bar unit and the number of streams lying beside one another and led out of the same are possible.

Common to all the turner bar units 20, 37, 38, 40 to 44 of FIGS. 1 to 10 is the fact that the webs 23 of the web printing material can be fed to the same simultaneously from two mutually opposite sides 24 and 25. The insertion directions 26 and 27 on the mutually opposite sides 24 and 25 are offset by 180° in relation to each other. The part webs 29 leave the turner bar units either on one side or on two opposite sides, the exit directions being arranged offset by 180° in relation to each other and in each case by 90° in relation to the insertion directions.

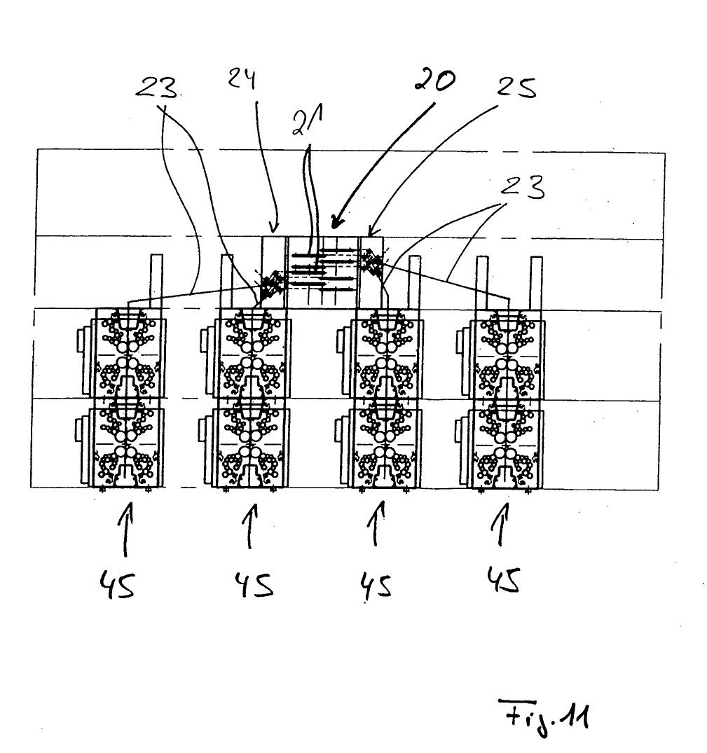

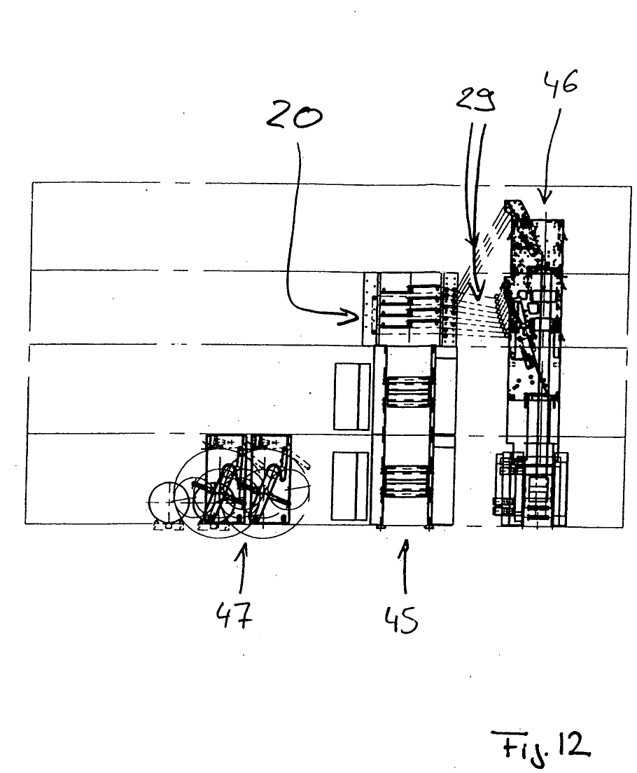

FIGS. 11 and 12 in each case show details of a web-fed rotary press in which, for example, the turner bar unit 20 of FIGS. 1 to 3 is used. Thus, FIG. 11 shows four printing unit towers 45 of a web-fed rotary press, the turner bar unit 20 according to the invention being positioned between the two central printing unit towers 45. The turner bar unit 20 can be supplied by each of the four printing unit towers 45 illustrated in FIG. 11 with webs 23 of a printed printing material, which can then be fed as part webs 29 to a folder superstructure 46 (see FIG. 12) of the web-fed rotary press. In addition to a printing unit tower 45, the turner bar unit 20 according to the invention and the folder superstructure 46, roll changers 47 are also shown in FIG. 12. Because the turner bar unit 20 according to the invention can be supplied with webs 23 simultaneously from two different sides 24 and 25, only one turner bar unit 20 is needed in the region of the printing unit towers 45. In this way, the printing unit towers 45 can be positioned at a shorter distance from one another, which ultimately results in advantages in terms of space for the entire web-fed rotary press. As a result of the omission of a second turner bar unit, required according to the prior art, advantages in terms of costs also result.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A turner bar unit for a web-fed rotary printing press, the turner bar unit comprising:
means for receiving unsevered webs of a web printing material from two sides of said unit in two respective insertion directions, said unsevered webs being received in a plurality of planes arranged one above another in each said insertion direction;
a plurality of turner bars arranged one above another in a plurality of planes; and
cutting devices arranged upstream of the turner bars in each said insertion direction, said cutting devices cutting each said unsevered web into part webs;
wherein said turner bars are arranged to deflect the part webs so that the part webs exit the turner bar unit at right angles to the insertion directions.

2. The turner bar unit of claim 1 wherein the unsevered webs can be received in said two insertion directions simultaneously, said two insertion directions being separated by about 180 degrees.

3. The turner bar unit of claim 1 further comprising means for feeding the part webs to the turner bars in a plurality of planes in two feed directions which are separated by about 180 degrees.

4. The turner bar unit of claim 3 wherein said means for feeding the part webs comprise rolls.

5. The turner bar unit of claim 1 wherein the part webs can exit the turner bar unit in two exit directions.

6. The turner bar unit of claim 5 wherein the two exit directions are separated by about 180 degrees.

7. A turner bar unit for a web-fed rotary press, the turner bar unit comprising:
means for receiving unsevered webs of printing material from two insertion directions in a plurality of planes arranged one above another in each said direction, said directions being separated by 180 degrees;
at least two rows of turner bars arranged transversely to said directions, each said row having at least two columns of turner bars, the turner bars in each said column being arranged one above another in a plurality of planes;
cutting devices arranged upstream of the turner bars in each said insertion direction, said cutting devices cutting each said unsevered web into web parts; and
means for guiding said part webs cut from each said unsevered web to turner bars in at least two said rows;
wherein said turner bars are arranged to deflect the part webs so that the part webs exit the columns at right angles to the insertion directions.

8. The turner bar unit of claim 7 wherein the unsevered webs can be received in two said insertion directions simultaneously.

9. The turner bar unit of claim 7 wherein the turner bars are arranged to deflect the part webs so that the part webs exit the columns in opposite directions.
